(19) United States
(12) Patent Application Publication
(10) Pub. No.: US 2018/0227714 A1
(43) Pub. Date: Aug. 9, 2018

(54) METHOD AND APPARATUS FOR MOTION DETECTION SYSTEMS

(71) Applicant: QUALCOMM Incorporated, San Diego, CA (US)

(72) Inventors: Youngsin Lee, Seoul (KR); Xiaoxin Zhang, Sunnyvale, CA (US)

(21) Appl. No.: 15/786,548

(22) Filed: Oct. 17, 2017

Related U.S. Application Data
(60) Provisional application No. 62/455,572, filed on Feb. 6, 2017.

(51) Int. Cl. H04W 4/02; G01S 5/02

(52) U.S. Cl. CPC H04W 4/027; H04L 67/12; G01S 5/0273

(57) ABSTRACT

Method, apparatus and systems for detecting motion of an object based on a received wireless signal include comparing a received wireless signal to an adaptive noise immunity threshold, if the received wireless signal satisfies the adaptive noise immunity threshold. The detecting motion is based at least in part on a comparison between a determined multipath amount of the received wireless signal and a reference multipath amount, and further by adjusting the adaptive noise immunity threshold from a first level to a second level prior to the comparing of the received wireless signal to the noise immunity threshold, where the second level is higher than the first level.

### TECHNICAL FIELD

This disclosure relates generally to wireless networks, and specifically to detecting the presence or motion of an object.

### DESCRIPTION OF THE RELATED TECHNOLOGY

A wireless local area network (WLAN) may be formed by one or more access points (APs) that provide a shared wireless medium for use by a number of client devices. Each AP, which may correspond to a Basic Service Set (BSS), periodically broadcasts beacon frames to enable compatible client devices within wireless range of the AP to establish and/or maintain a communication link with the WLAN. WLANs that operate in accordance with the IEEE 802.11 family of standards are commonly referred to as Wi-Fi networks.

The Internet of Things (IoT), which may refer to a communication system in which a wide variety of objects and devices wirelessly communicate with each other, is becoming increasingly popular in fields as diverse as environmental monitoring, building and home automation, energy management, medical and healthcare systems, and entertainment systems. IoT devices, which may include objects such as sensors, home appliances, smart televisions, light switches, thermostats, and smart meters, typically communicate with other wireless devices using communication protocols such as Bluetooth and Wi-Fi.

In at least one application of IoT, detecting an object or motion of an object in an environment where Wi-Fi network exits is highly desirable. The information resulting from detecting the motion of an object has many useful applications. For example, detecting motion of an object assists in identifying an unauthorized entry in a space. Therefore, it is important to detect the motion of an object in a reliable and accurate manner.

### SUMMARY

Method, apparatus and systems for detecting motion of an object based on a received wireless signal include comparing the received wireless signal to an adaptive noise immunity threshold, if the received wireless signal satisfies the adaptive noise immunity threshold. In at least one implementation, the detecting motion is based at least in part on a comparison between a determined multipath amount of the received wireless signal and a reference multipath amount, and further by adjusting the adaptive noise immunity threshold from a first level to a second level prior to the comparing of the received wireless signal to the noise immunity threshold, where the second level is higher than the first level.

### BRIEF DESCRIPTION OF THE DRAWINGS

FIG. 1 shows a block diagram of a wireless system.

FIG. 2 shows a block diagram of an access point.

FIG. 3 shows a block diagram of a wireless device.

FIG. 4A shows a transmission of a multipath wireless signal in a room without motion.

FIG. 4B shows a transmission of a multipath wireless signal in a room with motion.

FIG. 4C shows another transmission of a multipath wireless signal in a room with motion.

FIG. 5A shows an example channel impulse response of the multipath wireless signal of FIG. 4A.

FIG. 5B shows an example channel impulse response of the multipath wireless signal of FIG. 4B.

FIG. 6 shows an example ranging operation.

FIG. 7 shows another example ranging operation.

FIG. 8A shows an example fine timing measurement (FTM) request frame.

FIG. 8B shows an example FTM action frame.

FIG. 9 shows an example FTM parameters field.

FIG. 10 depicts a functional receiver block diagram including an Adaptive Noise Immunity (ANI) block in the receiver operation.

FIG. 11 depicts a function diagram of the Adaptive Noise Immunity block.

FIG. 12 depicts an exemplary flow of changes in the ANI threshold level over time.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network. Such systems or network are capable of transmitting and receiving RF signals. The transmission and reception of the signals may be according to any of the IEEE 802.16 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

Given the increasing number of IoT devices deployed in home and business networks, it is desirable to detect motion of objects or people in such networks. For example, one or more IoT devices can be turned on or off when a person enters or leaves a room or a space. However, because using motion sensors in such system and networks can increase costs and complexity, it would be desirable to detect motion without using motion sensors.

Implementations of the subject matter described in this disclosure may be used to detect motion using wireless RF signals rather than using an optical, ultrasonic, microwave or infrared motion sensing detectors. For some implementations, a first device may receive a wireless RF signal from a second device, and estimate channel conditions based on the wireless signal. The first device may detect motion of an object or a person based at least in part on the estimated channel conditions. In some aspects, the first device may detect motion based on one or more comparisons between the estimated channel conditions and a number of reference channel conditions. The number of reference channel conditions can be determined continuously, periodically, randomly, or at one or more specified times.

The wireless signal includes multipath signals associated with multiple arrival paths, and the detection of motion can be based on at least one characteristic of the multipath signals. In some implementations, the first device can detect motion by determining an amount of multipath based on the estimated channel conditions, comparing the determined amount of multipath with a reference amount, and indicating a presence of motion based on the determined amount of multipath differing from the reference amount by more than a value. The difference between the determined multipath amount and the reference multipath amount indicates presence or absence of motion in the space/room. In some aspects, the first device can determine the amount of multipath by determining a channel impulse response of the wireless signal, and determining a root mean square (RMS) value of a duration of the channel impulse response. In other aspects, the first device can determine the amount of multipath by determining a channel impulse response of the wireless signal, identifying a first tap and a last tap of the determined channel impulse response, and determining a duration between the first tap and the last tap.

In other implementations, the first device can detect motion by identifying a first arrival path of the wireless signal, determining a power level associated with the first arrival path, comparing the determined power level with a reference power level, and indicating a presence of motion based on the determined power level differing from the reference power level by more than a value.

As used herein, the term “HT” may refer to a high throughput frame format or protocol defined, for example, by the IEEE 802.11n standards; the term “VHT” may refer to a very high throughput frame format or protocol defined, for example, by the IEEE 802.11ac standards; the term “HE” may refer to a high efficiency frame format or protocol defined, for example, by the IEEE 802.11ax standards; and the term “non-HT” may refer to a legacy frame format or protocol defined, for example, by the IEEE 802.11a/g standards. Thus, the terms “legacy” and “non-HT” may be used interchangeably herein. In addition, the term “legacy device” as used herein may refer to a device that operates according to the IEEE 802.11a/g standards, and the term “HE device” as used herein may refer to a device that operates according to the IEEE 802.11ax or 802.11az standards.

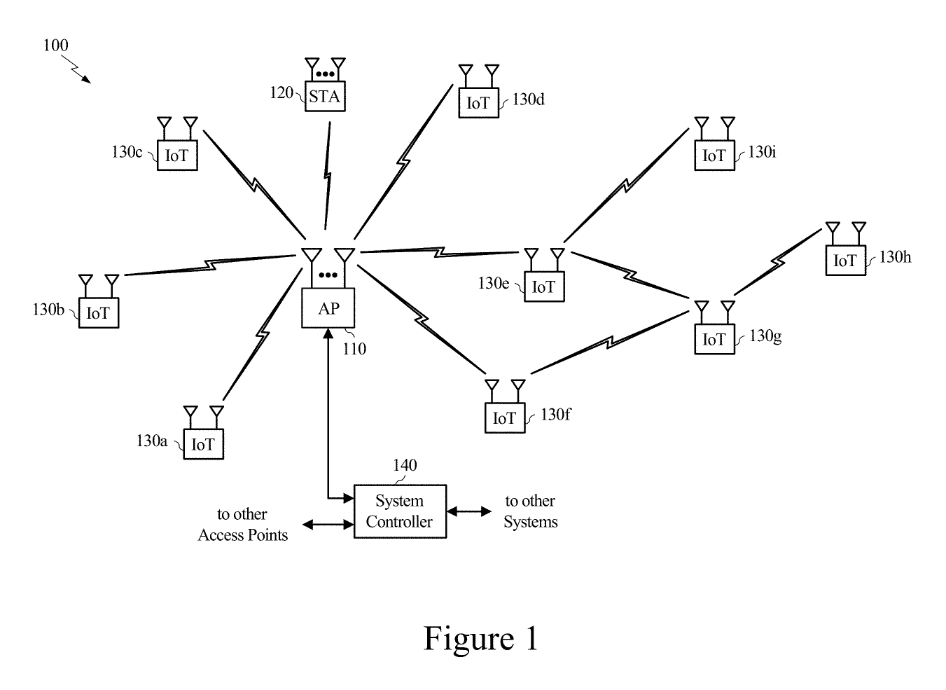

FIG. 1 shows a block diagram of an example wireless system 100. The wireless system 100 is shown to include a wireless access point (AP) 110, a wireless station (STA) 120, a plurality of Internet of Things (IoT) devices 130a-130h, and a system controller 140. For simplicity, only one AP 110 and only one STA 120 are shown in FIG. 1. The AP 110 may form a wireless local network (WLAN) that allows the AP 110, the STA 120, and the IoT devices 130a-130i to communicate with each other over a wireless medium. The wireless medium, which may be divided into a number of channels, may facilitate wireless communications via Wi-Fi signals (such as according to the IEEE 802.11 standards), via Bluetooth signals (such as according to the IEEE 802.15 standards), and other suitable wireless communication protocols. In some aspects, the STA 120 and the IoT devices 130a-130i can communicate with each other using peer-to-peer communications (such as without the presence or involvement of the AP 110).

In some implementations, the wireless system 100 may correspond to a multiple-input multiple-output (MIMO) wireless network, and may support single-user MIMO (SU-MIMO) and multi-user (MU-MIMO) communications. Further, although the wireless system 100 is depicted in FIG. 1 as an infrastructure Basic Service Set (BSS), in other implementations, the wireless system 100 may be an Independent Basic Service Set (IBSS), an Extended Basic Service Set, an ad-hoc network, a peer-to-peer (P2P) network (such as operating according to the Wi-Fi Direct protocols), or a mesh network. Thus, for at least some implementations, the AP 110, the STA 120, and the IoT devices 130a-130i can communicate with each other using multiple wireless communication protocols (such as Wi-Fi signals and Bluetooth signals).

The STA 120 may be any suitable Wi-Fi enabled wireless device including, for example, a cell phone, personal digital assistant (PDA), tablet device, laptop computers, or the like. The STA 120 also may be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some implementations, STA 120 may include a transceiver, one or more processing resources (such as processors or ASICs), one or more memory resources, and a power source (such as a battery). The memory resources may include a non-transitory computer-readable medium (such as one or more nonvolatile memory elements, such as EPROM, EEPROM, Flash memory, a hard drive, etc.) that stores instructions for performing operations described below.

Each of IoT devices 130a-130i may be any suitable device capable of operating according to one or more communication protocols associated with IoT systems. For example, the IoT devices 130a-130i can be a smart television, a smart appliance, a smart meter, a smart thermostat, a sensor, a gaming console, a set-top box, a smart light switch, and the like. In some implementations, the IoT devices 130a-130i can wirelessly communicate with each other, mobile station, access points, and other wireless devices using Wi-Fi signals, Bluetooth signals, and WiGig signals. For at least some implementations, each of IoT devices 130a-130i may include a transceiver, one or more processing resources (such as processors or ASICs), one or more memory resources, and a power source (such as a battery). The memory resources may include a non-transitory computer-readable medium (such as one or more nonvolatile memory elements, such as EPROM, EEPROM, Flash memory, a hard drive, etc.) that stores instructions for performing operations described below. In some implementations, each of the IoT devices 130a-130i may include fewer wireless transmission resources than the STA 120. Another distinction between STA 120 and the IoT devices 130a-130i may be that the IoT devices 130a-130i typically communicate with other wireless devices using relatively narrow channel widths (such as to reduce power consumption), while the STA 120 typically communicates with other wireless devices using relatively wide channel widths (such as to maximize data throughput). In some aspects, the IoT devices 130a-130i may communicate using narrowband communication protocols such as Bluetooth Low Energy (BLE). The capability of a device to operate an as IoT may be made possible by electronically attaching a transceiver card to the device. The transceiver card may be removable, and thus allowing the device to operate as an IoT for the time that the transceiver card is operating and interacting with the device and other IoT devices. For example, a television set with receptors to receive electronically such a transceiver card may be operate as an IoT when such a transceiver card has been attached and operating to communicate wireless signals with other IoT devices.

The AP 110 may be any suitable device that allows one or more wireless devices to connect to a network (such as a local area network (LAN), wide area network (WAN), metropolitan area network (MAN), or the Internet) via AP 110 using Wi-Fi, Bluetooth, cellular, or any other suitable wireless communication standards. For at least some implementations, AP 110 may include a transceiver, a network interface, one or more processing resources, and one or more memory sources. The memory resources may include a non-transitory computer-readable medium (such as one or more nonvolatile memory elements, such as EPROM, EEPROM, Flash memory, a hard drive, etc.) that stores instructions for performing operations described below. For other implementations, one or more functions of AP 110 may be performed by the STA 120 (such as operating as a soft AP). A system controller 140 may provide coordination and control for the AP 110 and/or for other APs within or otherwise associated with the wireless system 100 (other access points not shown for simplicity).

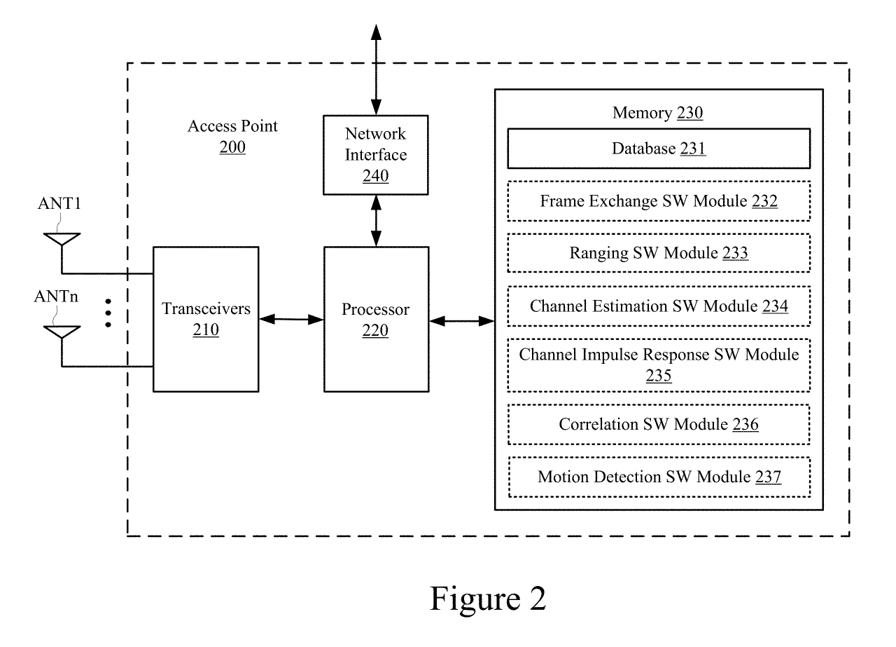

FIG. 2 shows an example access point 200. The access point (AP) 200 may be one implementation of the AP 110 of FIG. 1. The AP 200 may include one or more transceivers 210, a processor 220, a memory 230, a network interface 240, and a number of antennas ANT1-ANTn. The transceivers 210 may be coupled to antennas ANT1-ANTn, either directly or through an antenna selection circuit (not shown for simplicity). The transceivers 210 may be used to transmit signals to and receive signals from other wireless devices including, for example, the IoT devices 130a-130i and STA 120 of FIG. 1, or other suitable wireless devices. Although not shown in FIG. 2 for simplicity, the transceivers 210 may include any number of transmit chains to process and transmit signals to other wireless devices via antennas ANT1-ANTn, and may include any number of receive chains to process signals received from antennas ANT1-ANTn. Thus, the AP 200 may be configured for MIMO operations. The MIMO operations may include SU-MIMO operations and MU-MIMO operations. Further, in some aspects, the AP 200 may use multiple antennas ANT1-ANTn to provide antenna diversity. Antenna diversity may include polarization diversity, pattern diversity, and spatial diversity.

For purposes of discussion herein, processor 220 is shown as coupled between transceivers 210 and memory 230. For actual implementations, transceivers 210, processor 220, the memory 230, and the network interface 240 may be connected together using one or more buses (not shown for simplicity). The network interface 240 can be used to connect the AP 200 to one or more external networks, either directly or through the system controller 140 of FIG. 1.

Memory 230 may include a database 231 that may store location data, configuration information, data rates, MAC addresses, timing information, modulation and coding schemes, and other suitable information about (or pertaining to) a number of IoT devices, stations, and other APs. The database 231 also may store profile information for a number of wireless devices. The profile information for a given wireless device may include, for example, the wireless device's service set identification (SSID), channel information, received signal strength indicator (RSSI) values, goodput values, channel state information (CSI), and connection history with the access point 200.

Memory 230 also may include a non-transitory computer-readable storage medium (such as one or more nonvolatile memory elements, such as EPROM, EEPROM, Flash memory, a hard drive, and so on) that may store the following software modules:

a frame exchange software module 232 to create and exchange frames (such as data frames, control frames, management frames, and action frames) between AP 200 and other wireless devices, for example, as described in more detail below;

a ranging software module 233 to perform a number of ranging operations with one or more other devices, for example, as described in more detail below

a channel estimation software module 234 to estimate channel conditions and to determine a channel frequency response based on wireless signals transmitted from other devices, for example, as described in more detail below;

a channel impulse response software module 235 to determine or derive a channel impulse response based, at least in part, on the estimated channel conditions or the channel frequency response provided by the channel estimation software module 234, for example, as described in more detail below;

a correlation software module 236 to determine an amount of correlation between a number of channel impulse responses, for example, as described in more detail below; and

a motion detection module 237 to detect or determine a presence of motion in the vicinity of the AP 200 based at least in part on the estimated channel conditions or the determined amount of correlation between the channel impulse responses, for example, as described in more detail below.

Each software module includes instructions that, when executed by processor 220, may cause the AP 200 to perform the corresponding functions. The non-transitory computer-readable medium of memory 230 thus includes instructions for performing all or a portion of the operations described below.

The processor 220 may be any one or more suitable processors capable of executing scripts or instructions of one or more software programs stored in the AP 200 (such as within memory 230). For example, the processor 220 may execute the frame exchange software module 232 to create and exchange frames (such as data frames, control frames, management frames, and action frames) between AP 200 and other wireless devices. The processor 220 may execute the ranging software module 233 to perform a number of ranging operations with one or more other devices. The processor 220 may execute channel estimation software module 234 to estimate channel conditions and to determine a channel frequency response of wireless signals transmitted from other devices. The processor 220 may execute the channel impulse response software module 235 to determine or derive a channel impulse response based, at least in part, on the estimated channel conditions or the channel frequency response provided by the channel estimation software module 234. The processor 220 may execute the correlation software module 236 to determine an amount of correlation between a number of channel impulse responses. The processor 220 may execute the motion software detection module 237 to detect or determine a presence of motion in the vicinity of the AP 200 based at least in part on the estimated channel conditions or the determined amount of correlation between the channel impulse responses.

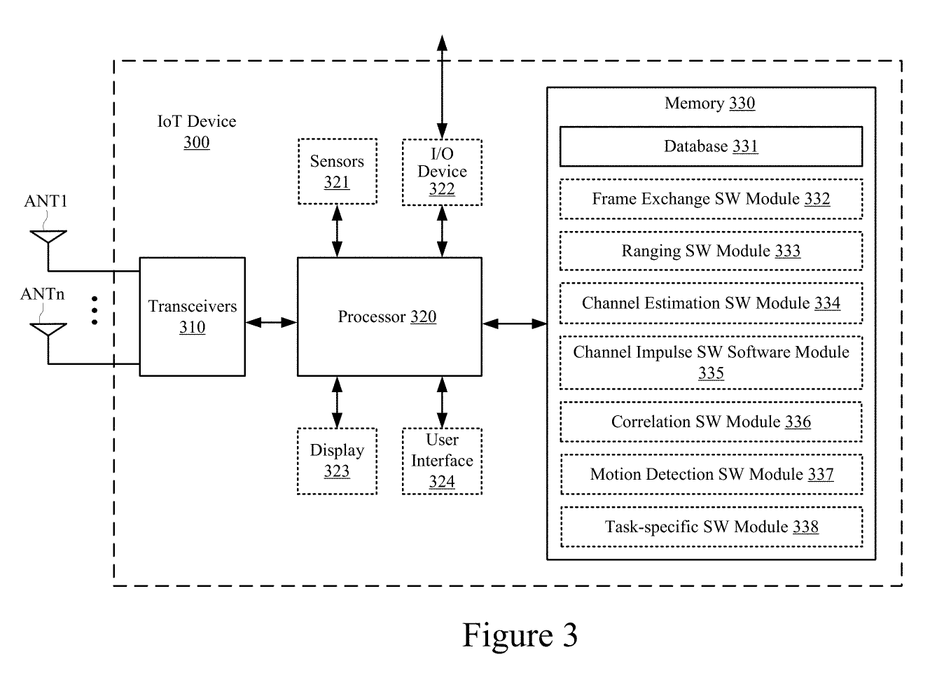

FIG. 3 shows an example IoT device 300. The IoT device 300 may be one implementation of the IoT devices 130a-130i of FIG. 1. The IoT device 300 includes one or more transceivers 310, a processor 320, a memory 330, and a number of antennas ANT1-ANTn. The transceivers 310 may be coupled to antennas ANT1-ANTn, either directly or through an antenna selection circuit (not shown for simplicity). The transceivers 310 may be used to transmit signals to and receive signals from APs, STAs, other IoT devices, or any other suitable wireless device. Although not shown in FIG. 3 for simplicity, the transceivers 310 may include any number of transmit chains to process and transmit signals to other wireless devices via antennas ANT1-ANTn, and may include any number of receive chains to process signals received from antennas ANT1-ANTn. For purposes of discussion herein, processor 320 is shown as coupled between transceivers 310 and memory 330. For actual implementations, transceivers 310, processor 320, and memory 330 may be connected together using one or more buses (not shown for simplicity).

The IoT device 300 may optionally include one or more of sensors 321, an input/output (I/O) device 322, a display 323, a user interface 324, and any other suitable component. For one example in which IoT device 300 is a smart television, the display 323 may be a TV screen, the I/O device 324 may provide audio-visual inputs and outputs, the user interface 324 may be a control panel, a remote control, and so on. For another example in which IoT device 300 is a smart appliance, the display 323 may provide status information, and the user interface 324 may be a control panel to control operation of the smart appliance. The functions performed by such IoT devices may vary in complexity and function. As such, one or more functional blocks shown in IoT device 300 may not be present and/or additional functional blocks may be present. The IoT device may be implemented with minimal hardware and software complexity. For example, the IoT device functioning as a light switch may have far less complexity than the IoT device implemented for a smart television. Moreover, any possible device may be converted into an IoT device by electronically connecting to a removable electronic card which includes one or more functionalities shown in FIG. 3. The device would functionally interact with the electronic card. For example, an older generation television set could be converted to a smart television by inserting the electronic card in an input port of the television, and allowing the electronic card to interact with the operation of the television.

Memory 330 may include a database 331 that stores profile information for a plurality of wireless devices such as APs, stations, and/or other IoT devices. The profile information for a particular AP may include information including, for example, the AP's SSID, MAC address, channel information, RSSI values, certain parameters values, CSI, supported data rates, connection history with the AP, a trustworthiness value of the AP (e.g., indicating a level of confidence about the AP's location, etc.), and any other suitable information pertaining to or describing the operation of the AP. The profile information for a particular IoT device or station may include information including, for example, device's MAC address, IP address, supported data rates, and any other suitable information pertaining to or describing the operation of the device.

Memory 330 also may include a non-transitory computer-readable storage medium (such as one or more nonvolatile memory elements, such as EPROM, EEPROM, Flash memory, a hard drive, and so on) that may store the following software (SW) modules:

a frame exchange software module 332 to create and exchange frames (such as data frames, control frames, management frames, and action frames) between the IoT device 300 and other wireless devices, for example, as described in more detail below;

a ranging software module 333 to perform a number of ranging operations with one or more other devices, for example, as described in more detail below

a channel estimation software module 334 to estimate channel conditions and to determine a channel frequency response based on wireless signals transmitted from other devices, for example, as described in more detail below;

a channel impulse response software module 335 to determine or derive a channel impulse response based, at least in part, on the estimated channel conditions or the channel frequency response provided by the channel estimation software module 334, for example, as described in more detail below;

a correlation software module 336 to determine an amount of correlation between a number of channel impulse responses, for example, as described in more detail below;

a motion detection software module 337 to detect or determine a presence of motion in the vicinity of the IoT device 300 based at least in part on the estimated channel conditions or the determined amount of correlation between the channel impulse responses, for example, as described in more detail below; and

a task-specific software module 338 to facilitate the performance of one or more tasks that may be specific to IoT device 300.

Each software module includes instructions that, when executed by processor 320, may cause the IoT device 300 to perform the corresponding functions. The non-transitory computer-readable medium of memory 330 thus includes instructions for performing all or a portion of the operations described below.

The processor 320 may be any one or more suitable processors capable of executing scripts or instructions of one or more software programs stored in the IoT device 300 (such as within memory 330). For example, the processor 320 may execute the frame exchange software module 332 to create and exchange frames (such as data frames, control frames, management frames, and action frames) between the IoT device 300 and other wireless devices. The processor 320 may execute the ranging software module 333 to perform a number of ranging operations with one or more other devices. The processor 320 may execute channel estimation software module 334 to estimate channel conditions and to determine a channel frequency response of wireless signals transmitted from other devices. The processor 320 may execute the channel impulse response software module 335 to determine or derive a channel impulse response based, at least in part, on the estimated channel conditions or the channel frequency response provided by the channel estimation software module 334. The processor 320 may execute the correlation software module 336 to determine an amount of correlation between a number of channel impulse responses. The processor 320 may execute the motion software detection module 337 to detect or determine a presence of motion in the vicinity of the IoT device 300 based at least in part on the estimated channel conditions or the determined amount of correlation between the channel impulse responses.

The processor 320 may execute the task-specific software module 338 to facilitate the performance of one or more tasks that may be specific to IoT device 300. For one example in which IoT device 300 is a smart TV, execution of the task specific software module 338 may cause the smart TV to turn on and off, to select an input source, to select an output device, to stream video, to select a channel, and so on. For another example in which IoT device 300 is a smart thermostat, execution of the task specific software module 338 may cause the smart thermostat to adjust a temperature setting in response to one or more signals received from a user or another device. For another example in which IoT device 300 is a smart light switch, execution of the task specific software module 338 may cause the smart light switch to turn on/off or adjust a brightness setting of an associated light in response to one or more signals received from a user or another device. In some implementations, execution of the task-specific software module 338 may cause the IoT device 300 to turn on and off based on a detection of motion, for example, by the motion detection software module 337.

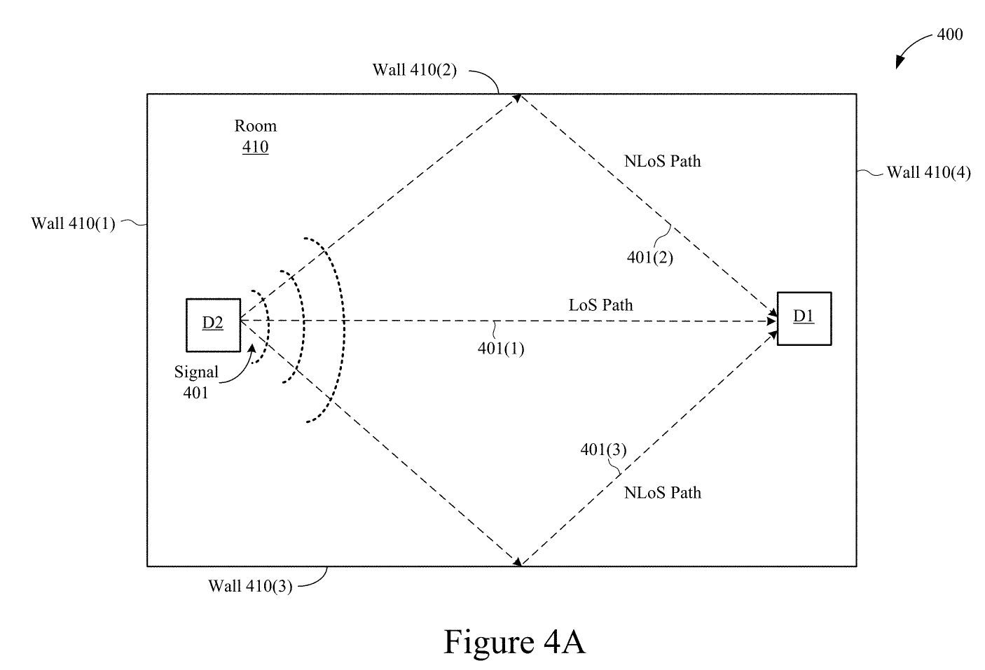

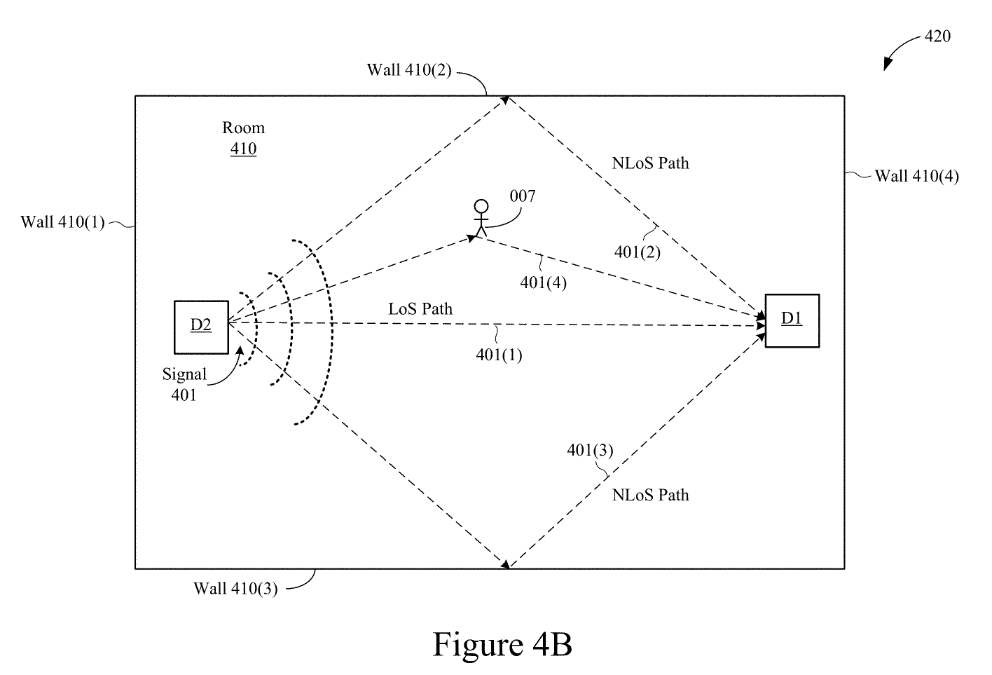

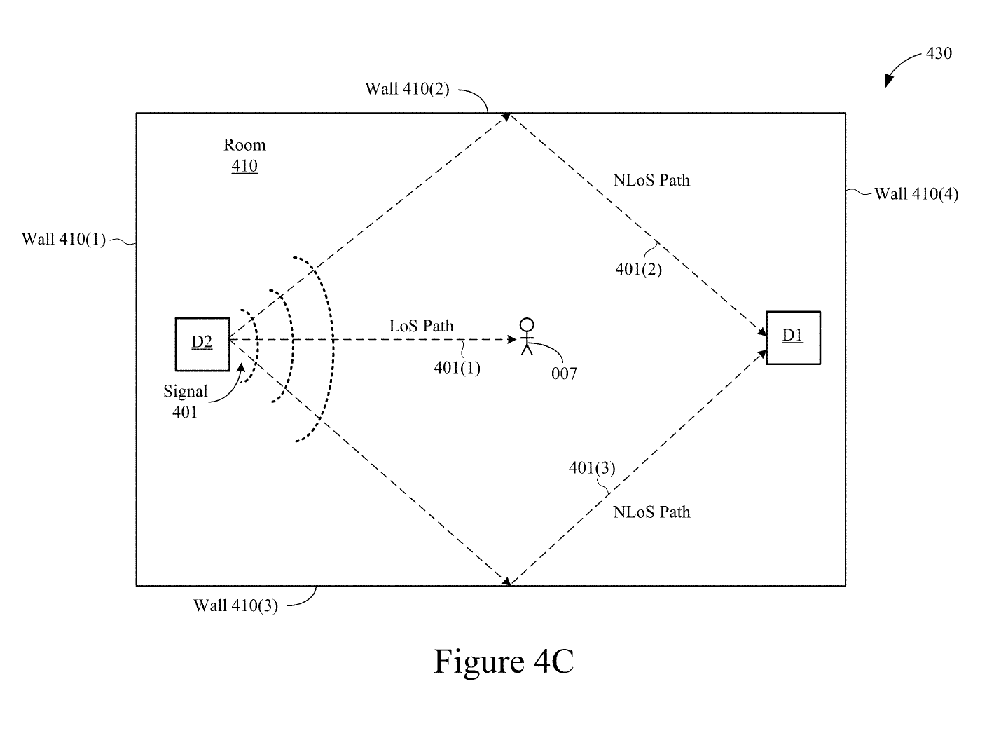

FIG. 4A shows a transmission of a multipath wireless signal in a room 410 without motion. As depicted in FIG. 4A, a first device D1 receives a wireless signal 401 transmitted from a second device D2. The wireless signal 401 may be any suitable wireless signal from which channel conditions can be estimated including, for example, a data frame, a beacon frame, a probe request, an ACK frame, a timing measurement (TM) frame, a fine timing measurement (FTM) frame, a null data packet, and so on. In a signal propagation space where objects and/or walls are in the vicinity of the source of the signal transmission, certain multipath effect would be experienced. The receiving end of the signal would invariably experience receiving the transmitted signal through such multipath effect. In the example of room 410, the wireless signal 401 may be influenced by multipath effects. The effects may be due, for example, from at least walls 410(2 and 3) and other obstacles and objects, such as furniture. For simplicity, the multipath effect is shown to produce a first signal component 401(1), a second signal component 401(2), and a third signal component 401(3). The first signal component 401(1) travels directly from device D2 to device D1 along a line-of-signal (LOS) path, the second signal component 401(2) travels indirectly from device D2 to device D1 along a non-LOS (NLOS) path that reflects off wall 410(2), and the third signal component 401(3) travels indirectly from device D2 to device D1 along a NLOS path that reflects off wall 410(3). As a result, the first signal component 401(1) may arrive at device D1 at different times or at different angles compared to the second signal component 401(2) or the third signal component 401(3).

It is noted that although only two NLOS signal paths are depicted in FIG. 4A, the wireless signal 401 may have any number of signal components that travel along any number of NLOS paths between device D2 and device D1. Further, although the first signal component 401(1) is depicted as being received by device D1 without intervening reflections, for other examples, the first signal component 401(1) may be reflected one or more times before received by device D1.

As mentioned above, it would be desirable for device D1 to detect motion in its vicinity (such as within the room 410) without using a separate or dedicated motion sensor. Thus, in accordance with various aspects of the present disclosure, device D1 can use the wireless signal 401 transmitted from device D2 to detect motion within the room 410. More specifically, device D1 can estimate channel conditions based at least in part on the wireless signal 401, and then detect motion based at least in part on the estimated channel conditions. Thereafter, device D1 can perform a number of operations based on the detected motion. For example, device D1 can turn itself on when motion is detected, and can turn itself off when motion is not detected for a time period. In yet another example, it may simply alert a user about detection of motion in room 410.

As depicted in FIG. 4A, the wireless signal 410 includes multipath signals associated with multiple arrival paths. As a result, the detection of motion in room 410 may be based on at least one characteristic of the multipath signals. For purposes of discussion herein, there is no motion in room 410 at the time depicted in FIG. 4A (such as a night when no one is in the room or during times when no one is at home or walking through room 410). For purposes of discussion herein, the signal propagation of the room 410 depicted in FIG. 4A may be associated with an observation at a first time T1 when no motion is expected to be occurring in room 410. In some implementations, device D1 estimates channel conditions when there is no motion in room 410, and then designates these estimated channel conditions as reference channel conditions. The reference channel conditions can be stored in device D1 or in any other suitable device coupled to device D1, for example, as occurring at the first time T1. It is noted that device D1 can estimate or determine the reference channel conditions continuously, periodically, randomly, or at one or more specified times (such as when there is no motion in the room 410).

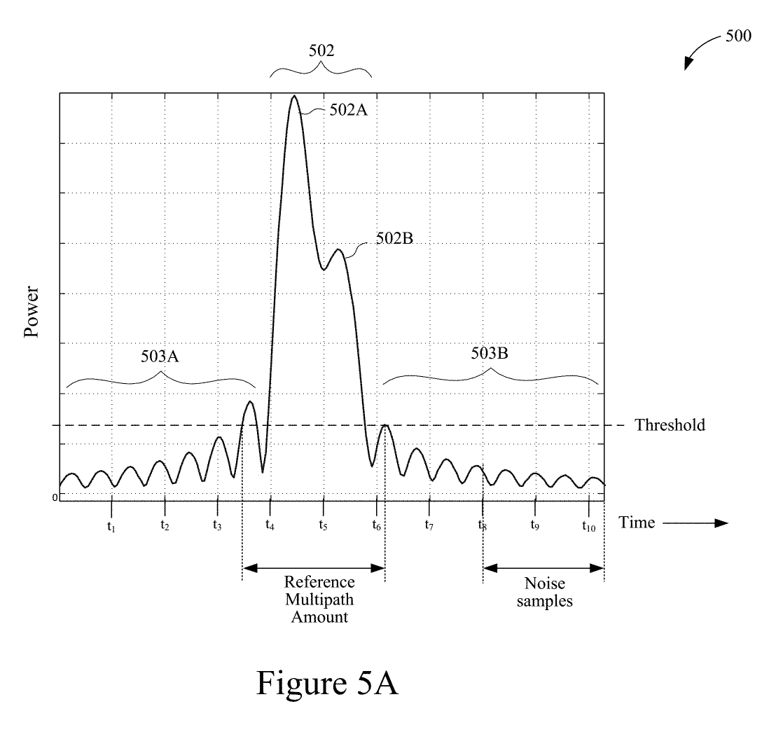

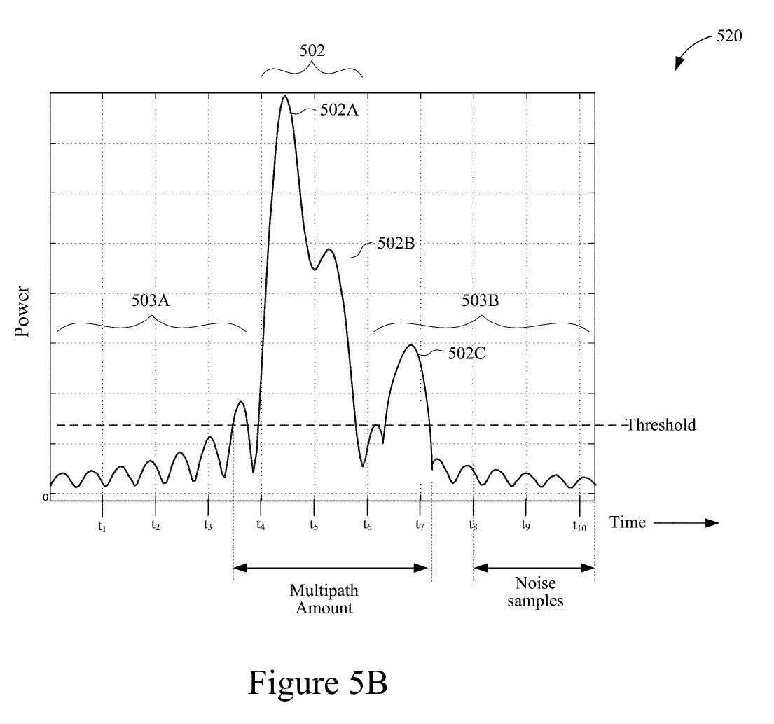

FIG. 5A shows an example channel impulse response 500 of the wireless signal 401 of FIG. 4A. The channel impulse response 500 may be expressed in terms of power (y-axis) as a function of time (x-axis). As described above with respect to FIG. 4A, the wireless signal 401 includes line-of-sight (LOS) signal components and non-LOS (NLOS) signal components, and is received by device D1 in the presence of multipath effects. In some implementations, device D1 may determine the channel impulse response 500 by taking an Inverse Fourier Transfer (IFT) function of a channel frequency response of the received wireless signal 401. Thus, in some aspects, the channel impulse response 500 may be a time-domain representation of the wireless signal 401 of FIG. 4A. Because the wireless signal 401 of FIG. 4A includes an LOS signal component 401(1) and a number of NLOS signal components 401(2)-401(3), the channel impulse response 500 of FIG. 5A may be a superposition of multiple sinc pulses, each associated with a corresponding peak or “tap” at a corresponding time value.

More specifically, the channel impulse response 500 is shown to include a main lobe 502 occurring between approximately times t4 and t6, and includes a plurality of secondary lobes 503A and 503B on either side of the main lobe 502. The main lobe 502 includes a first peak 502A and a second peak 502B of different magnitudes, for example, caused by multipath effects. The first peak 502A, which has a greater magnitude than the second peak 502B, may represent the signal components traveling along the first arrival path (FAP) to device D1 of FIG. 4A. In some aspects, the main peak 502A can be the first arrival in the channel impulse response 500, and can represent the LOS signal components as well as one or more NLOS signal components that may arrive at device D1 at the same time (or nearly the same time) as the LOS signal components. The taps associated with secondary lobes 503A and 503B can be later arrivals in the channel impulse response 500, and can represent the NLOS signal components arriving at device D1.

As shown in FIG. 5A, a threshold power level may be selected, and the portion of the channel impulse response 500 that exceeds the threshold power level may be designated as the amount of multipath. In other words, for the example of FIG. 5A, the amount of multipath may be expressed as the duration of the channel impulse response 500 that exceeds the threshold power level. Portions of the channel impulse response 500 associated with later signal arrivals that fall below the threshold power level may be designated as noise samples in sampling of the incoming signal. The amount of multipath determined from the channel impulse response 500 of FIG. 5A may be stored in device D1 (or another suitable device) and thereafter used to detect motion in the room 410 at other times.

In some aspects, the amount of multipath can be measured as the Root Mean Square (RMS) of channel delay (such as the duration of multipath longer than a threshold). It is noted that the duration of the multipath is the width (or time delay) of the entire channel impulse response 500; thus, while only portions of the channel impulse response corresponding to the first arrival path are typically used when estimating angle information of wireless signal, the entire channel impulse response may be used when detecting motion as disclosed herein. The threshold power level can be set according to either the power level of the strongest signal path power or to the noise power.

The device D1 can use the reference multipath amount determined at time T1 to detect motion in the room at one or more later times. For example, FIG. 4B shows the transmission of a multipath wireless signal in the room 410 with motion. For purposes of discussion herein, the room 410 depicted in FIG. 4B may be associated with multipath signal propagation occurring at a second time T2. As depicted in FIG. 4B, a person 007 has entered the room 410 and caused at least an additional NLOS signal 401(4). The additional NLOS signal 401(4) resulting from the presence or movement of person 007 may change the channel conditions, for example, as compared to the channel conditions of the room 410 at the first time T1 (as depicted in FIG. 4A). In accordance with various aspects of the present disclosure, device D1 can use changes in estimated channel conditions between times T1 and T2 to detect movement of an object/person (motion) in the room 410. More specifically, device D1 can estimate channel conditions based on the signal 401 of FIG. 4B (which include the “new” NLOS signal 401(4)), and then compare the estimated channel conditions at the second time T2 with the reference channel conditions estimated at the first time T1.

FIG. 5B shows an example channel impulse response 520 of the wireless signal 401 at time T2, as depicted in FIG. 4B. The channel impulse response 520 is similar to the channel impulse response 500 of FIG. 5A, except that the multipath amount at time T2 is greater (such as having a longer duration) than the reference multipath amount depicted in FIG. 5A, and there is an extra peak 502C corresponding to the NLOS signal 401(4) caused by the presence or movement of person 007 in room 410. Thus, in some aspects, the change in multipath amount between time T1 and time T2 can be used to detect motion in the vicinity of device D1 (such as in the room 410).

FIG. 4C shows the transmission of a multipath wireless signal in the room 410 when the person 007 obstructs the LOS signal 401(1). For purposes of discussion herein, the room 410 depicted in FIG. 4C may be associated with a third time T3. As shown in FIG. 4C, the location of the person 007 may prevent the wireless signal 401 from having a LOS signal component 401(1) that reaches device D1. The absences of the LOS signal component 401(1) may cause the channel conditions at time T3 to be different from the channel conditions at time T2 (see FIG. 4B) and to be different from the channel conditions at time T1 (see FIG. 4A). Device D1 can use changes in estimated channel conditions between either times T1 and T3 or between times T2 and T3 (or a combination of both) to detect motion in the room 410. Thus, in some aspects, device D1 can estimate channel conditions based on the signal 401 of FIG. 4C, and then compare the estimated channel conditions at time T3 with the reference channel conditions estimated at time T1 to detect motion. In other aspects, device D1 can estimate channel conditions based on the signal 401 of FIG. 4C, and then compare the estimated channel conditions at time T3 with the channel conditions estimated at time T2 to detect motion.

In other implementations, device D1 can use the first arrival path (FAP) of the channel impulse response 520 to detect motion when the person 007 blocks the LOS signal components, for example, as depicted in FIG. 4C. More specifically, device D1 can determine whether the power level of the FAP signal component has changed by more than a threshold value, for example, by comparing the power level of the FAP signal component of the channel impulse response at time T1 with the power level of the FAP signal component of the channel impulse response at time T3. In some aspects, device D1 can compare the absolute power levels of the FAP between time T1 and time T3.

In other aspects, device D1 can compare relative power levels of the FAP between time T1 and time T3. More specifically, device D1 can compare the power level of the FAP relative to the entire channel power level to determine a relative power level for the FAP signal components. By comparing relative power levels (rather than absolute power levels), the overall channel power can be normalized, for example, to compensate for different receive power levels at time T1 and time T3. For example, even though the person 007 is not obstructing the LOS signal (as depicted in FIG. 4B at time T2), it is possible that the overall receive power level may be relatively low. Conversely, even though the person 007 obstructs the LOS signal (as depicted in FIG. 4C at time T3), it is possible that the overall power level may be relatively high.

In some other implementations, device D1 can compare the shapes of channel impulse responses determined at different times to detect motion. For example, device D1 can compare the shape of channel impulse response 500 (determined at time T1) with the shape of channel impulse response 520 (determined at time T2) by determining a correlation between the channel impulse responses 500 and 520. In some aspects, device D1 can use a covariance matrix to determine the correlation between the channel impulse responses 500 and 520. In other aspects, device D1 can perform a sweep to determine a correlation between a number of identified peaks of the channel impulse response 500 and a number of identified peaks of the channel impulse response 520, and then determine whether the identified peaks of the channel impulse response 500 are greater in power than the identified peaks of the channel impulse response 520. Further, if motion is detected, then device D1 can trigger additional motion detection operations to eliminate false positives and/or to update reference information (such as the reference multipath amount).

In addition, or in the alternative, device D1 can base a detection of motion on comparisons between FAP power levels and comparisons of multipath amounts.

In accordance with other aspects of the present disclosure, device D1 can solicit the transmission of one or more wireless signals from device D2, for example, rather than waiting to receive wireless signals transmitted from another device (such as device D2 in the examples of FIGS. 4A-4C). In some aspects, device D1 can initiate an active ranging operation to solicit a response frame from device D2, use the received response frame to estimate channel conditions, and thereafter detect motion based on the estimated channel conditions.

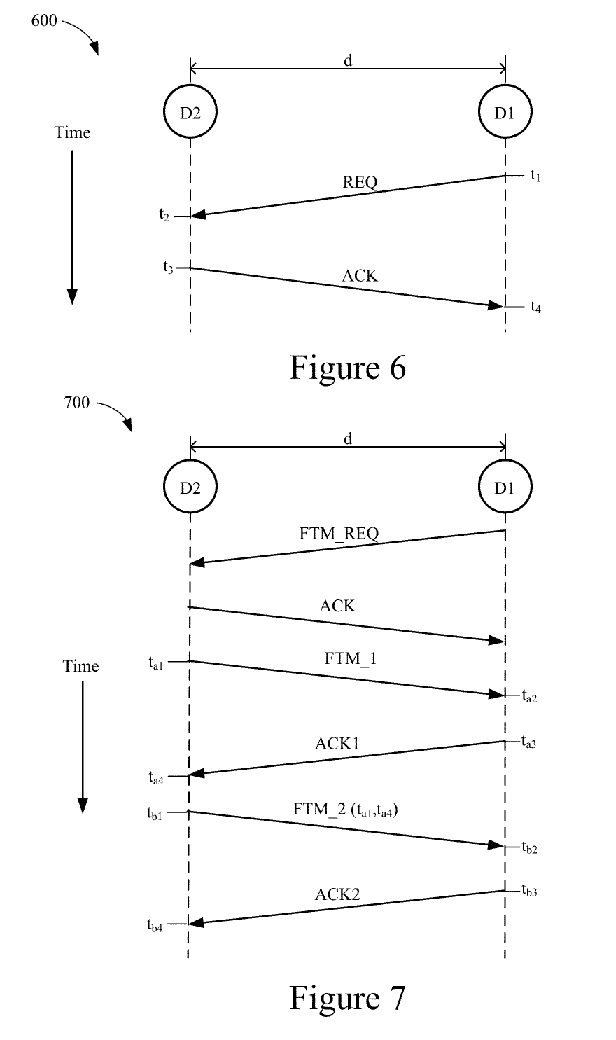

FIG. 6 shows a signal diagram of an example ranging operation 600. The example ranging operation 600, which is performed between first and second devices D1 and D2, may be used to detect motion in the vicinity of the first device D1. In some implementations, the first device D1 is an IoT device (such as one of IoT devices 130a-130i of FIG. 1 or the IoT device 300 of FIG. 3), and the second device D2 is an AP (such as the AP 110 of FIG. 1 or the AP 200 of FIG. 2). For example, device D1 may be a smart television located in the room 410 depicted in FIGS. 4A-4C, and device D2 may be an access point located in the room 410 depicted in FIGS. 4A-4C. In other implementations, each of the first and second devices D1 and D2 may be any suitable wireless device (such as a STA, an AP, or an IoT device). For the ranging operation 600 described below, device D1 is the initiator device (also known as the “requester device”), and the device D2 is the responder device.

At time t1, device D1 transmits a request (REQ) frame to device D2, and device D2 receives the REQ frame at time t2. The REQ frame can be any suitable frame that solicits a response frame from device D2 including, for example, a data frame, a probe request, a null data packet (NDP), and so on. At time t3, device D2 transmits an acknowledgement (ACK) frame to device D1, and device D1 receives the ACK frame at time t4. The ACK frame can be any frame that is transmitted in response to the REQ frame.

After the exchange of the REQ and ACK frames, device D1 may estimate channel conditions based at least in part on the ACK frame received from device D2. Then, device D1 may detect motion based at least in part on the estimated channel conditions. In some aspects, device D1 may use the estimated channel conditions to determine a channel frequency response (based on the ACK frame), and may then determine a channel impulse response based on the channel frequency response (such as by taking an IFT function of the channel frequency response).

For at least some implementations, device D1 may capture the time of departure (TOD) of the REQ frame, device D2 may capture the time of arrival (TOA) of the REQ frame, device D2 may capture the TOD of the ACK frame, and device D2 may capture the TOA of the ACK frame. Device D2 may inform device D1 of the time values for t2 and t3, for example, so that device D1 has timestamp values for t1, t2, t3, and t4. Thereafter, device D1 may calculate the round trip time (RTT) value of the exchanged FTM_REQ frame and ACK frames as RTT=(t4−t3)+(t2−t1). The distance (d) between the first device D1 and the second device D2 may be estimated as d=c*RTT/2, where c is the speed of light.

FIG. 7 shows a signal diagram of an example ranging operation 700. The example ranging operation 700, which is performed between first and second devices D1 and D2, may be used to detect motion in the vicinity of the first device D1. In some implementations, the first device D1 is an IoT device (such as one of IoT devices 130a-130i of FIG. 1 or the IoT device 300 of FIG. 3), and the second device D2 is an AP (such as the AP 110 of FIG. 1 or the AP 200 of FIG. 2). For example, device D1 may be a smart television located in the room 410 depicted in FIGS. 4A-4C, and device D2 may be an access point located in the room 410 depicted in FIGS. 4A-4C. In other implementations, each of the first and second devices D1 and D2 may be any suitable wireless device (such as a STA, an AP, or an IoT device). For the ranging operation 700 described below, device D1 is the initiator device (also known as the “requester device”), and the device D2 is the responder device.

Device D1 may request or initiate the ranging operation 700 by transmitting a fine timing measurement (FTM) request (FTM_REQ) frame to device D2. Device D1 may use the FTM_REQ frame to negotiate a number of ranging parameters with device D2. For example, the FTM_REQ frame may specify at least one of a number of FTM bursts, an FTM burst duration, and a number of FTM frame exchanges per burst. In addition, the FTM_REQ frame may also include a request for device D2 to capture timestamps (e.g., TOA information) of frames received by device D2 and to capture timestamps (e.g., TOD information) of frames transmitted from device D2.

Device D2 receives the FTM_REQ frame, and may acknowledge the requested ranging operation by transmitting an acknowledgement (ACK) frame to device D1. The ACK frame may indicate whether device D2 is capable of capturing the requested timestamps. It is noted that the exchange of the FTM_REQ frame and the ACK frame is a handshake process that not only signals an intent to perform a ranging operation but also allows devices D1 and D2 to determine whether each other supports capturing timestamps.

At time ta1, device D2 transmits a first FTM (FTM_1) frame to device D1, and may capture the TOD of the FTM_1 frame as time ta1. Device D1 receives the FTM_1 frame at time ta2, and may capture the TOA of the FTM_1 frame as time ta2. Device D1 responds by transmitting a first FTM acknowledgement (ACK1) frame to device D2 at time ta3, and may capture the TOD of the ACK1 frame as time ta3. Device D2 receives the ACK1 frame at time ta4, and may capture the TOA of the ACK1 frame at time ta4. At time tb1, device D2 transmits to device D1 a second FTM (FTM_2) frame. Device D1 receives the FTM_2 frame at time tb2, and may capture its timestamp as time tb2.

In some implementations, device D1 may estimate channel conditions based on one or more of the FTM frames transmitted from device D2. Device D1 may use the estimated channel conditions to detect motion in its vicinity, for example, as described above with respect to FIGS. 4A-4C and FIGS. 5A-5B. In addition, device D2 may estimate channel conditions based on one or more of the ACK frames transmitted from device D1. Device D2 may use the estimated channel conditions to detect motion in its vicinity, for example, as described above with respect to FIGS. 4A-4C and FIGS. 5A-5B. In some aspects, device D2 may inform device D1 whether motion was detected in the vicinity of device D2 by providing an indication of detected motion in one or more of the FTM frames. In some aspects, device D2 may use a reserved bit in the FTM_1 frame or the FTM_2 frame to indicate whether device D2 detected motion.

In addition, the FTM_2 frame may include the timestamps captured at times ta1 and ta4 (e.g., the TOD of the FTM_1 frame and the TOA of the ACK1 frame). Thus, upon receiving the FTM_2 frame at time tb2, device D1 has timestamp values for times ta1, ta2, ta3, and ta4 that correspond to the TOD of the FTM_1 frame transmitted from device D2, the TOA of the FTM_1 frame at device D1, the TOD of the ACK1 frame transmitted from device D1, and the TOA of the ACK1 frame at device D2, respectively. Thereafter, device D1 may determine a first RTT value as RTT1=(ta4−ta3)+(ta2−ta1). Because the value of RTT1 does not involve estimating SIFS for either device D1 or device D2, the value of RTT1 does not involve errors resulting from uncertainties of SIFS durations. Consequently, the accuracy of the resulting estimate of the distance between devices D1 and D2 is improved (e.g., as compared to the ranging operation 600 of FIG. 6).

Although not shown in FIG. 7 for simplicity, devices D1 and D2 may exchange additional pairs of FTM and ACK frames, for example, where device D2 embeds the timestamps of a given FTM and ACK frame exchange into a subsequent FTM frame transmitted to device D1. In this manner, device D1 may determine an additional number of RTT values.

The accuracy of RTT and channel estimates between wireless devices may be proportional to the frequency bandwidth (the channel width) used for transmitting the FTM and ACK frames. As a result, ranging operations for which the FTM and ACK frames are transmitted using a relatively large frequency bandwidth may be more accurate and may provide better channel estimates than ranging operations for which the FTM and ACK frames are transmitted using a relatively small frequency bandwidth. For example, ranging operations performed using FTM frame exchanges on an 80 MHz-wide channel provide more accurate channel estimates than ranging operations performed using FTM frame exchanges on a 40 MHz-wide channel, which in turn provide more accurate channel estimates than ranging operations performed using FTM frame exchanges on a 20 MHz-wide channel.

Because Wi-Fi ranging operations may be performed using frames transmitted as orthogonal frequency-division multiplexing (OFDM) symbols, the accuracy of RTT estimates may be proportional to the number of tones (such as the number of OFDM sub-carriers) used to transmit the ranging frames. For example, while a legacy (such as non-HT) frame may be transmitted on a 20 MHz-wide channel using 52 tones, an HT frame or VHT frame may be transmitted on a 20 MHz-wide channel using 56 tones, and an HE frame may be transmitted on a 20 MHz-wide channel using 242 tones. Thus, for a given frequency bandwidth or channel width, FTM ranging operations performed using HE frames provide more accurate channel estimates than FTM ranging operations performed using VHT frames, FTM ranging operations performed using HE frames provide more accurate channel estimates than FTM ranging operations performed using VHT frames, and FTM ranging operations performed using HE frames provide more accurate channel estimates than FTM ranging operations performed using VHT frames.

Thus, in some implementations, the ACK frames of the example ranging operation 700 may be one of a high-throughput (HT) frame, a very high-throughput (VHT) frame, or a high-efficiency (HE) frame, for example, so that device D1 can estimate channel conditions over a wider bandwidth as compared with legacy frames (such as 20 MHz-wide frames exchanged in the example ranging operation 600 of FIG. 6). Similarly, in some implementations, the FTM frames of the example ranging operation 700 may be one of a high-throughput (HT) frame, a very high-throughput (VHT) frame, or a high-efficiency (HE) frame, for example, so that device D2 can estimate channel conditions over a wider bandwidth as compared with legacy frames (such as 20 MHz-wide frames exchanged in the example ranging operation 600 of FIG. 6).

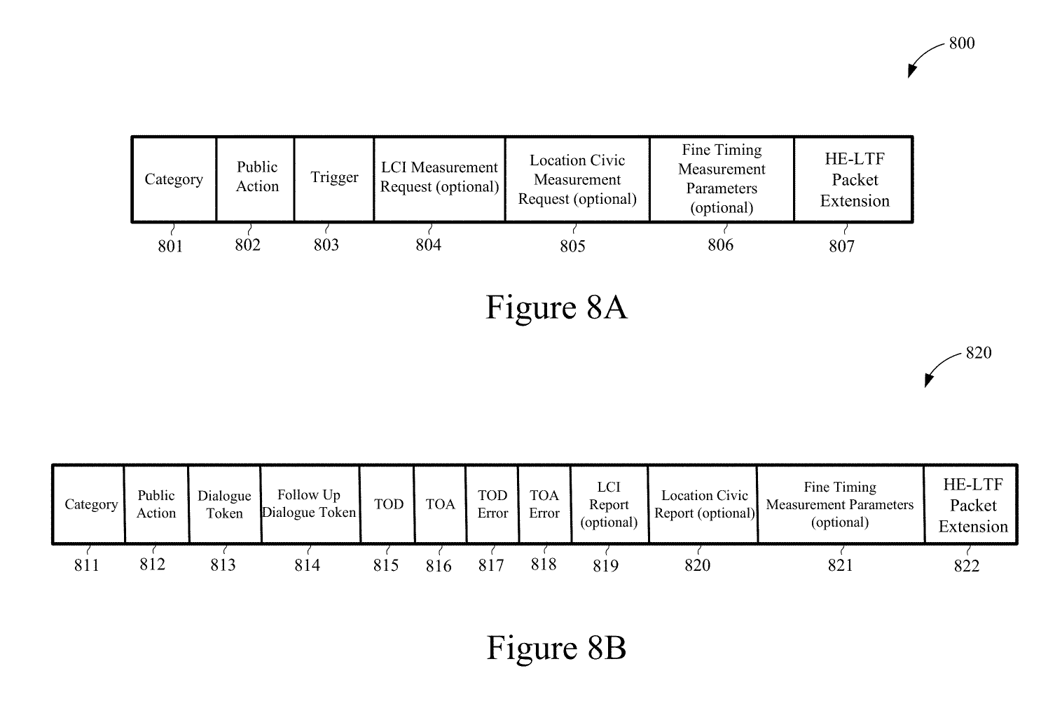

FIG. 8A shows an example FTM_REQ frame 800. The FTM_REQ frame 800 may be one implementation of the FTM_REQ frame depicted in the ranging operation 700 of FIG. 7. The FTM_REQ frame 800 may include a category field 801, a public action field 802, a trigger field 803, an optional location civic information (LCI) measurement request field 804, an optional location civic measurement request field 805, and an optional FTM parameters field 806. The fields 801-806 of the FTM_REQ frame 800 are well-known, and therefore are not discussed in detail herein. In some aspects, the FTM_REQ frame 800 may include a packet extension 807. The packet extension 807 can contain one or more sounding sequences such as, for example, HE-LTFs.

FIG. 8B depicts an example FTM frame 810. The FTM frame 810 may be one implementation of the FTM_1 and FTM_2 frames depicted in the example ranging operation of FIG. 7. The FTM frame 810 may include a category field 811, a public action field 812, a dialogue token field 813, a follow up dialog token field 814, a TOD field 815, a TOA field 816, a TOD error field 817, a TOA error field 818, an optional LCI report field 818, an optional location civic report field 820, and an optional FTM parameters field 821. The fields 811-821 of the FTM frame 810 are well-known, and therefore are not discussed in detail herein.

In some aspects, the FTM frame 810 may include a packet extension 822. The packet extension 822 may contain one or more sounding sequences such as, for example, HE-LTFs. As described above, a number of reserved bits in the TOD error field 817 and/or the TOA error field 818 of FTM frame 810 may be used to store an antenna mask.

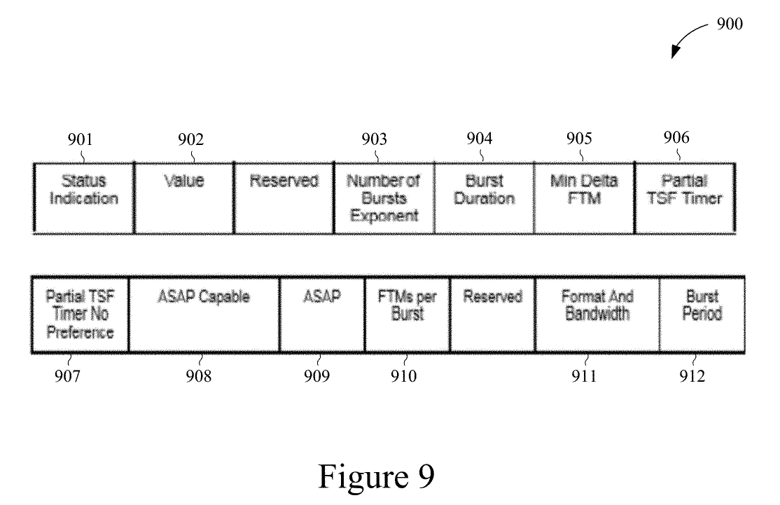

FIG. 9 shows an example FTM parameters field 900. The FTM parameters field 900 is shown to include a status indication field 901 that may be used to indicate the responding device's (such as device D2 of FIGS. 4A-4C) response to the FTM_REQ frame. The number of bursts exponent field 903 may indicate a number of FTM bursts to be included in the ranging operation of FIG. 7. The burst duration field 904 may indicate a duration of each FTM burst in the ranging operation of FIG. 7. The FTMs per burst field 910 may indicate how many FTM frames are exchanged during each burst in the ranging operation of FIG. 7. The burst period field 912 may indicate a frequency (such as how often) of the FTM bursts in the ranging operation of FIG. 7.

The environment where the measurements for determining the reference multipath amount, the multipath amount for detection of motion, and the ranging operation are performed is preferably an environment with low levels of the interference and noise. The interference and noise may be produced by the operation of the device, such as devices D1, D2 and other devices in the same general area. In case the device D1 is a smart television, the source of such a noise may be from an operation of the television. In most instances, the source of such interference and noise are not clearly known nor could be controlled in an efficient manner. In the example of a smart television, unbeknown to the user about over the air measurements, the user may turn on/off the television set, which in turn could produce unwanted noise and interference.

While referring to the graphs depicted in FIGS. 5A and 5B, the resulting measured multipath amount at times T1 and T2 may be effected by the noise generated from the device D1 or other sources. Similarly, if there is a signal interference, the resulting multipath amount would not be accurate. If additional noise is present, for example, at time T1, the measured multipath amount may be much higher because the level of the noise samples would be higher resulting in a higher multipath amount measured at time T1. Considering the noise may not be present during the measurement of the multipath amount at time T2, the level of noise samples would be lower than the levels experienced during time T1. Similarly, if there is a signal interference at either times T1 or T2, the resulting multipath amounts would not be accurate. As such, the reference multipath amount, the multipath amount for detection of motion, and the ranging operation may negatively be effected by variability of the interference in the propagation environment and presence of variable noise levels experienced by the device D1.

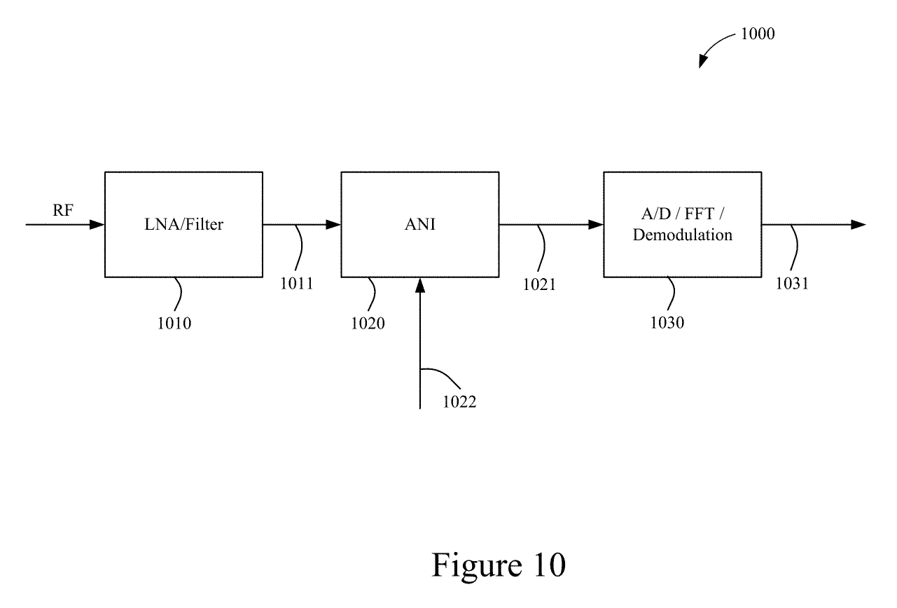

In order to address the negative effect of interference and noise in the measurements at different times, the receive operation of the device D1 is dynamically adjusted for determining the reference multipath amount, the multipath amount for detection of motion, and the ranging operation. Device D1 may be an AP, STA or IoT as shown in FIG. 1. Such devices normally operate to receive signals from each other for the purpose of communicating to each other. The transmission and reception of such signals may be in accordance with OFDM techniques. While referring to FIGS. 2 and 3, one or more aspects of the receive operation of transceivers 210 and 310 may be shown by the receiver block diagram 1000 in FIG. 10. The radio frequency (RF) signal received from the antenna(s) is input to a front-end processing block 1010. The front-end processing in block 1010 may include amplifying the received RF signal through a low noise amplifier and filtering the signal from some of the unwanted signals received at the antenna. The resulting signal 1011 is then input to an Adaptive Noise Immunity (ANI) block 1020. The most basic operation of ANI block 1020 is to selectively limit passing of the received signal. If passing of the received signal is selected, the ANI block 1020 passes the received signal 1011 as an output signal 1021 which may also be used as a trigger for block 1030 for further receive processing of the signal. The operation performed in block 1030 may include analog to digital conversion, FFT and demodulation of the received signal. The output signal 1031 may be the demodulated data for further processing by, for example, the processor 220 or 320. The operation and interconnection of the exemplary processor blocks 220 and 320 have been shown in references to FIGS. 2 and 3.

The ANI block 1020 improves the operation of the receiver by selectively limiting the passing of the signals to block 1030. The signal 1011 which is an output of the LNA/filter block 1010 may be in the form of an analog RF signal. The ANI block 1020 compares the signal 1011 to an ANI threshold. The comparison of the signal 1011 to the ANI threshold may be in a form of comparing the peak signal levels of signal 1011 to the ANI threshold. The comparison may alternatively or in addition be made based on the magnitude of the signal 1011. Presence of low peak signal levels or low signal magnitude in a received signal may be considered as an indication that the received signal is not at an acceptable level for further processing and may also include undesired noise or interference. For example, if the peak signal level and/or the magnitude of the received signal is below the ANI threshold, the ANI block 1020 prevents passing of the signal 1011 to block 1030. As a result, the block 1030 would not spend time trying to perform demodulation or FFT of the received signal which is considered to have mainly noise and/or interference. The comparison of the signal 1011 to an ANI threshold in ANI block 1020 may be in a form of analog and/or digital signal processing. In one or more examples, the total magnitude of the received signal 1011 may be compared to the ANI threshold, or the average magnitude of the received signal 1011 computed over a time period may be compared to the ANI threshold. The received signal 1011 may be digitized through a digital signal sampling process and/or processed through analog signal amplitude detectors, both commonly known to one of ordinary skilled in the art.

The ANI block 1020 also has an input control signal 1022. The control signal 1022 may control selection of the ANI threshold level in ANI block 1020. The control signal 1022 may be generated by processor 220 or 320 shown in references to FIGS. 2 and 3. The processor in one or more connection with the back-end processing of the received signal may determine the error packet rate, symbol errors, etc. of the received signal. If the error rate is increasing or has increased above an acceptable level (i.e. an indication of an unacceptable amount of decoding error in the received signal), the processor may determine that noise level or interference level of the received signal is at an unacceptable level. In such a case, the control signal 1022 is used to select a higher ANI threshold level in ANI block 1020 so that only stronger signals be passed to the block 1030 for further receive processing. Similarly, if the error rate is decreasing or has decreased below a level (i.e., less error in decoding the received signal), the processor may determine that noise level or interference level of the received signal is at or below a low level. In such a case, the control signal 1022 is used to either maintaining the same ANI threshold level or selecting a lower level ANI threshold in ANI block 1020 so that weaker signals can also be passed to the block 1030 for demodulation and receive processing.

Different levels of ANI threshold are generally available for selection in ANI block 1020. A particular level of ANI threshold is selected depending on the operation being performed at the time. If the selected ANI threshold is at a low level, the receiver is considered very sensitive. With the ANI threshold set at a low level, the receiver would then pass most received signals including the weaker signals to block 1030. However, with low ANI threshold, noise and interference may also pass through. Presence of noise and interference in signal 1021 may cause the block 1030 to be triggered for demodulation and operate on noise and interference, which is an undesirable receive operation. If the selected ANI threshold level is at a high level, the overall operation of the receiver is reduced to only receiving strong signals, which may be considered undesirable under certain conditions. As such, the selection of ANI threshold level in ANI block 1020 may be made dynamic and adaptive to a particular operation being performed by the device, for example in device D1.

The operation of ANI block 1020 includes switching among a set of ANI thresholds, where the ANI threshold is changed from one level to another level. Each ANI threshold level limits passing of the received signal at a particular level. There may be as many as ten or more different ANI threshold levels. For example, the ANI threshold at the lowest level provides the lowest level of immunity against noise and interference. Similarly, the ANI threshold at the highest level provides the highest immunity level. For example, when device D1 is expecting to receive an OFDM signal, control signal 1022 may select an initial ANI threshold level. If the packet error rate experienced by the device increases, the initial ANI threshold level is increased to limit passing of weak signals to block 1030 for demodulation. Conversely, when the pack error rate is reduced, the ANI threshold level may be lowered. In another example, when the device D1 is looking to find OFDM signals, the selected ANI threshold may be at a low level. When a desired OFDM signal is detected, the ANI threshold may be increased based on the strength of the detected OFDM signal. The duration for which an ANI threshold level is used may also be selected by control signal 1022. The duration for use of a selected ANI threshold may be set adaptively or preselected. The period for which a selected ANI threshold is used therefore may change and adapt to the condition at different times. For example, the period may be longer when the device D1 is searching for an OFDM signal and shorter when the device is demodulating an OFDM signal.

With respect to determining the multipath amount as described in relation to FIGS. 4A-C and the ranging operation, one or more ANI thresholds may be used. The level of selected ANI threshold for determining multipath values may be at a higher level when compared to the ANI threshold used during other general operations of the device D1. As such, during the multipath measurements, including both the reference multipath and subsequently the motion multipath measurements, the receiver 1000 sensitivity is considerably reduced. With the reduced receiver sensitivity through an adjustment of increasing the ANI threshold, the measurements for determining the multipath reference and subsequently multipath for detection of motion most likely produce an accurate result. Considering the receiver block 1030 would not as a result be triggered by noise or unwanted signal to process the received signal, the profile of the multipath would be more accurate resulting in an accurate determination of the reference multipath amount and the motion multipath amount. As such, the receiver would be able to detect motion with far fewer false positive data points.

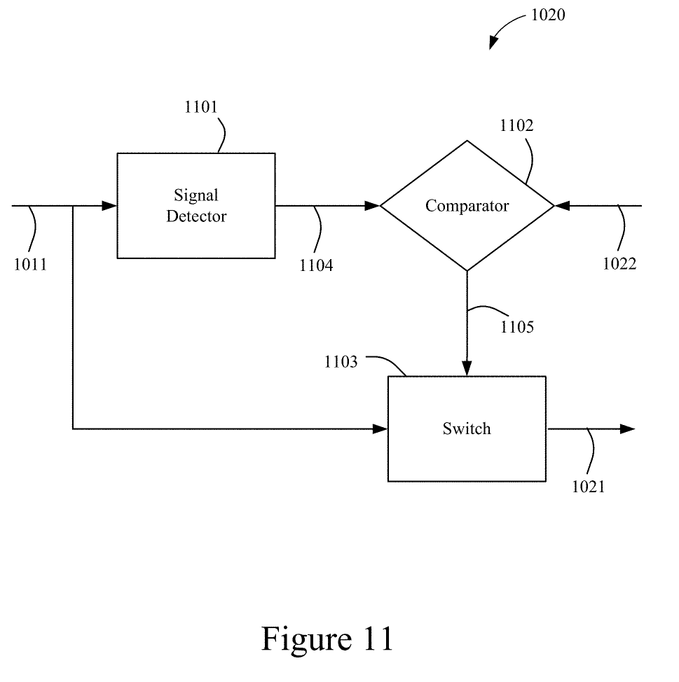

Referring to FIG. 11, a functional block diagram of ANI block 1020 is shown. Signal 1011 is an input to signal detector block 1101 and signal switch 1103. Signal detector 1101 may determine peak signal levels and/or magnitude of the received signal 1011 and pass the resulting value to a comparator 1102. The peak signal level or magnitude of the signal 1011 may be determined, for example, by a digital signal processing of the signal 1011 through digital signal sampling. Moreover, the magnitude of the received signal may also be determined through a process commonly known as Quadrature Phase sampling to determine In-phase and Quadrature phase (I and Q) levels of the received signal 1011. The magnitude of the received signal is then determined based on adding the squared values of the I and Q levels and taking the square root of the added squared values. The measurements and calculation of the peak signal levels and signal magnitude may be taken over a particular frequency bandwidth of the expected received signal 1011, and may include a process for averaging the measurements over a particular time period. The peak signal level and/or signal magnitude 1104 is then passed on to the comparator 1102. The peak signal level and/or the signal magnitude 1104 is then compared in comparator 1102 to a selected ANI threshold. The control signal 1022 controls the selection of the ANI threshold and the duration for which the same ANI threshold is used. The output of the comparator 1102 is a control signal 1105 which controls the signal switch 1103. If the peak signal level and/or signal magnitude 1104 satisfies the selected ANI threshold (i.e. above the threshold), the control signal 1105 allows the signal switch 1103 to pass the received signal 1011 as the signal 1021 for further processing and demodulation. If the peak signal level and/or signal magnitude 1104 does not satisfy the selected ANI threshold (i.e. below the threshold), the control signal 1105 prevents the signal switch 1103 to pass the received signal 1011 as the signal 1021 for further processing and demodulation. While preventing the signals that do not satisfy the selected ANI threshold, the processing of the signal for motion detection is more accurate and consistent than otherwise.

The control signal 1022 for selection of ANI threshold is generated by the processor (e.g. processor 220 and 320). The processor in a connection with the motion detection software module (e.g. 237 and 337) controls the level of the selected ANI threshold, as explained throughout. Other software modules, device interfaces and functional blocks may also be involved in the process. For example, the software modules in memory block (e.g. 230 and 330) of device D1 may be involved in the process of determining the level of the selected ANI threshold and the duration for which the selected ANI threshold should be used.

Considering at certain times of the day the possibility of presence of noise is less than other times, the level of ANI threshold may be different at such times than other times. For example, the possibility of presence of noise during the early hours after midnight is less than during the day when significant number of activities may be taking place in the room and the nearby spaces. Therefore, for multipath measurement, the ANI threshold selected at the early hours after midnight may be lower than the ANI threshold selected during the day. Similarly, for multipath measurement, the duration for which the receive operation of device D1 switches to a particular level of ANI threshold may be different depending on the time of the measurement. The selected duration in the hours after midnight may be longer than the selected duration at other times.

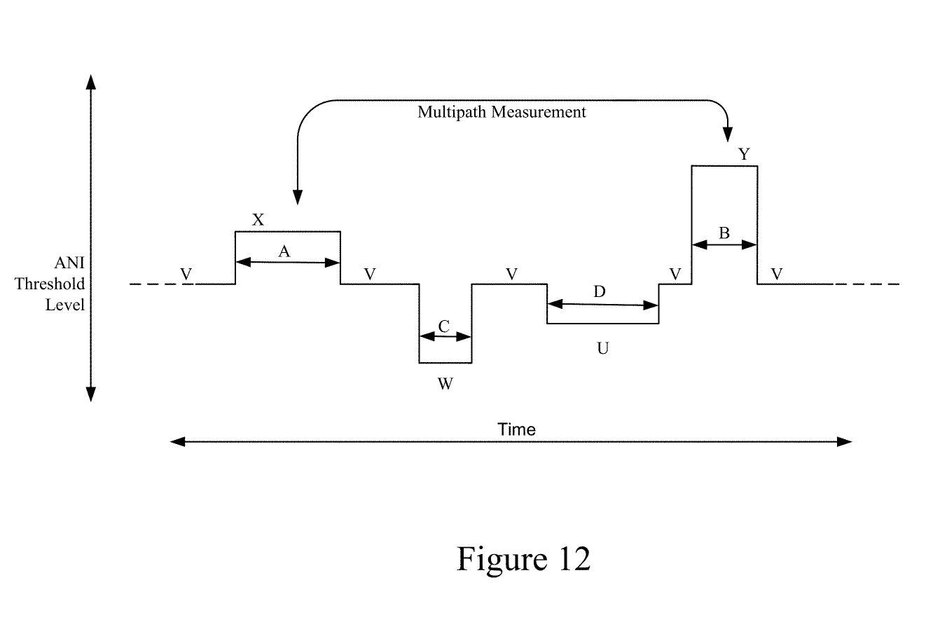

Referring to FIG. 12, a graphical analysis of possible changes to the ANI threshold is provided. The level of ANI threshold is shown on the vertical line and the expiring time is shown on the horizontal line. The ANI threshold levels V, X, W, U and Y are selected at different times. The duration for maintaining a selected ANI threshold is also shown. Durations A, C, D and B are identified. The control signal 1022 selects an ANI threshold and the duration depending on the condition and the type of function being performed. For multipath measurements and determination of multipath values, the ANI threshold is at a higher level than the ANI threshold selected during the normal operation. In the examples shown in FIG. 12, ANI threshold V may be the threshold selected during the normal operation, and for the duration A, the ANI threshold X which is higher than ANI threshold V is selected for the multipath measurements. At the expiration of the duration A, the ANI threshold may revert back to the ANI threshold level V. With respect to the durations C and D, ANI threshold levels W and U are respectively selected depending on the type of the operations being performed for example by device D1. The receiver may be searching or demodulating an OFDM signal in the durations C and D. With respect to the duration B which multipath measurements may be taking place, the selected ANI threshold level Y is used which is higher than the other ANI threshold levels used at other times including the ANI threshold level X. In this example, the ANI threshold level Y may have been selected because presence of significant amount of noise and interference is suspected based on the performance and operation of the device D1 prior to the duration B. With respect to the ANI threshold level X which is shown to be lower than the ANI threshold level Y, less amount of noise and interference may have been suspected for the duration A than the duration B. Therefore, the ANI threshold levels for multipath measurements may be different at different times and may be dynamically adjusted over time. Moreover, the respective durations used for measuring the multipath amounts may be different at different times. Considering that in the duration A presence of less noise and interference is suspected than in the duration B, the duration A may be longer than the duration B. Therefore, the selection of ANI threshold levels and/or the duration for use of the selected ANI threshold is adaptive to the device condition, and the ANI threshold is changed from one level to another when device D1 begins operating to make the measurements for determining the multipath values. The ANI threshold level is changed again after the multipath measurement is completed.

Considering the multipath profile of the environment may change very often and presence of noise and interference are unpredictable, the measurements taken for determining the reference multipath amount, the multipath amount for detection of motion, and the ranging operation may be repeated several times to collect several data points. Collecting data several times and at different times reduces the possibility of having false positive detection of motion and miss capturing detection of motion. For example, the measurements for determining the reference multipath amount and the multipath amount for detection of motion may be repeated periodically with a preselected periodicity or performed randomly. The user of device D1 may also be able to set the periodicity of the measurements. The user may also be able to select the measurements to be taken on demand by interacting with the device D1 locally or remotely. The ranging operation may also run periodically or on demand by the user. The ranging operation may also be repeated several times, successively or randomly spaced, to collect data for improving accuracy. For example, the ranging operation may be repeated several times within a time period, and each repeated operation may be separated by one or more specific time period. Moreover, if the result shows presence of motion in the room, the process may be repeated for one or more times to improve accuracy of the result. For example, if the process has been repeated K number of times, and Q number of times a motion has been detected, the process may output detection of a motion in the room. Different values for K and Q may be selected at different times and conditions. For example, the values for K and Q may be different for motion detection in one room/space than another room/space. In a room/space where detection of motion is difficult because the arrangement of the room/space is producing a multipath profile that is difficult to evaluate for determining a multipath value, a higher value for K and Q may be selected. A multipath profile with many peaks and at low level is more difficult to evaluate for determining a multipath value than with a multipath profile with few peaks and at high level. The values for K and Q may also be different depending on time of the day. For example, one might expect to have more movement in a space during certain hours of the day than other times (e.g. after midnight). As a result, the values for K and Q may be lower during night hours because of expecting less movement. Furthermore, when presence of noise and interference is more expected, the values for K and Q may be different than other times.

Moreover, a process of using the statistical analysis of the determined data points may be used to improve the accuracy of the results. For example, selecting a data point at the median points of the output data to determine the reference multipath amount may improve reliability of the determined the determined multipath amount. In another example, the data points appearing at outlier of the spectrum of data points may be ignored or removed from the collected data to improve accuracy and reliability of detecting motion.

The result of the motion detection may be used in a number of ways for controlling operating mode of the device D1 and/or other devices. For example, device D1 may change its operating mode from an ON mode to an OFF mode when no particular motion has been detected in the room/space for some time. In case of a television being device D1, the television may turn itself to an OFF mode when no motion has been detected in the room for some time. The result of the motion detection may also be used to control an operating mode of other devices. For example, the lights in the room/space may be dimmed or turned OFF, when no motion has been detected for some time. The result of the motion detection may also be communicated to a relay device for the result to be communicated to a remote location.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blue-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those of ordinary skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A method for motion detection based on a received wireless signal, the method comprising:
comparing the received wireless signal to an adaptive noise immunity threshold; and
detecting motion of an object based at least in part on the received wireless signal, if the received wireless signal satisfies the adaptive noise immunity threshold.

2. The method of claim 1 wherein the detecting motion is based at least in part on a determined multipath amount of the received wireless signal.

3. The method of claim 2 wherein the detecting motion includes:
determining a reference multipath amount; and
indicating a presence of motion based on a difference between the determined multipath amount of the received signal and the determined reference multipath amount.

4. The method of claim 1 further comprising: adjusting the adaptive noise immunity threshold from a first level to a second level prior to the comparing of the received wireless signal to the adaptive noise immunity threshold.

5. The method of claim 4 wherein the second level of the adaptive noise immunity threshold is higher than the first level of the adaptive noise immunity threshold.

6. The method of claim 4 further comprising: maintaining the adaptive noise immunity threshold at the second level for a period of time, and at an expiration of the period of time, changing the adaptive noise immunity threshold to either the first level or another level.

7. The method of claim 1 further comprising: determining a level of the adaptive noise immunity threshold based on one or more parameters including received packet error rate, time of a day, a multipath profile of the received wireless signal, and periodicity of performing the detecting motion.

8. The method of claim 1, wherein the detecting motion is performed periodically, randomly, or at one or more specified times.

9. The method of claim 1, wherein the received wireless signal is at least one of a probe response frame, an acknowledgement (ACK) frame, a timing measurement (TM) frame, a fine timing measurement (FTM) frame, a null data packet (NDP), and a beacon frame.

10. The method of claim 1, wherein the received wireless signal is received at least at one of a smart television, a smart appliance, a smart meter, a smart thermostat, a set-top box, and a smart light switch, and transmitted from at least one of an access point, a mobile station, and a relay device.

11. The method of claim 1, further comprising:
configuring an operating mode of a device based on whether the detecting motion produces an indication of a presence of motion.

12. The method of claim 1, further comprising:
communicating to one or more devices whether the detecting motion has produced an indication of a presence or absence of motion.

13. An apparatus for motion detection based on a received wireless signal, the apparatus comprising:
a comparator for comparing the received wireless signal to an adaptive noise immunity threshold; and
a processor configured for detecting motion of an object based at least in part on the received wireless signal, if the received wireless signal satisfies the adaptive noise immunity threshold.

14. The apparatus of claim 13, wherein the processor is further configured to base the detecting motion at least in part on a determined multipath amount of the received wireless signal.

15. The apparatus of claim 14, wherein the processor is further configured for determining a reference multipath amount, and indicating a presence of motion based on a difference between the determined multipath amount of the received signal and the determined reference multipath amount.

16. The apparatus of claim 13 wherein the processor is further configured for adjusting the adaptive noise immunity threshold from a first level to a second level prior to the comparing of the received wireless signal to the adaptive noise immunity threshold.

17. The apparatus of claim 16 wherein the second level of the adaptive noise immunity threshold is higher than the first level of the adaptive noise immunity threshold.

18. The apparatus of claim 16 wherein the processor is further configured for maintaining the noise immunity threshold at the second level for a period of time, and at an expiration of the period of time, changing the adaptive noise immunity threshold to either the first level or another level.

19. The apparatus of claim 13 wherein the processor is further configured for determining a level of the adaptive noise immunity threshold based on one or more parameters including received packet error rate, time of a day, a multipath profile of the received wireless signal, and periodicity of performing the detecting motion.

20. The apparatus of claim 13, wherein the processor is configured for performing the detecting motion periodically, randomly, or at one or more specified times.

21. The apparatus of claim 13, wherein the received wireless signal is at least one of a probe response frame, an acknowledgement (ACK) frame, a timing measurement (TM) frame, a fine timing measurement (FTM) frame, a null data packet (NDP), and a beacon frame.

22. The apparatus of claim 13, wherein the received wireless signal is received at least at one of a smart television, a smart appliance, a smart meter, a smart thermostat, a set-top box, and a smart light switch, and transmitted from at least one of an access point, a mobile station, and a relay device.

23. The apparatus of claim 13, wherein the processor is further configured for communicating to one or more devices whether the detecting motion has produced an indication of a presence or absence of motion.

24. A non-transitory computer readable storage medium comprising instructions that when executed cause a wireless device to perform motion detection based on a received wireless signal, the medium comprising instructions for:
comparing the received wireless signal to an adaptive noise immunity threshold; and
detecting motion of an object based at least in part on the received wireless signal, if the received wireless signal satisfies the adaptive noise immunity threshold.

25. The non-transitory computer readable storage medium of claim 24 wherein the detecting motion is based at least in part on a determined multipath amount of the received wireless signal.

26. The non-transitory computer readable storage medium of claim 25 further comprising instructions for: determining a reference multipath amount; and indicating a presence of motion based on a difference between the determined multipath amount of the received signal and the determined reference multipath amount.

27. The non-transitory computer readable storage medium of claim 24 further comprising instructions for: adjusting the adaptive noise immunity threshold from a first level to a second level prior to the comparing of the received wireless signal to the adaptive noise immunity threshold.

28. The non-transitory computer readable storage medium of claim 27 further comprising instructions for selecting the second level of the adaptive noise immunity threshold to be higher than the first level of the adaptive noise immunity threshold.

29. The non-transitory computer readable storage medium of claim 27 further comprising instructions for maintaining the adaptive noise immunity threshold at the second level for a period of time, and at an expiration of the period of time, changing the adaptive noise immunity threshold to either the first level or another level.

30. An apparatus for motion detection based on a received wireless signal, the apparatus comprising:
means for comparing the received wireless signal to an adaptive noise immunity threshold; and
means for detecting motion of an object based at least in part on the received wireless signal, if the received wireless signal satisfies the adaptive noise immunity threshold.
